(19) United States
(12) Patent Application Publication
(10) Pub. No.: US 2011/0045432 A1
(43) Pub. Date: Feb. 24, 2011

(54) SIMPLE LINKING DEVICE

(76) Inventors: Randall C. Groscurth, Troy, MI (US); Shoko U. Groscurth, Troy, MI (US)

Correspondence Address: Michael B. Stewart;Rader, Fishman & Grauer PLLC, 39533 Woodward Avenue, Suite 140, Bloomfield Hills, MI, 48304, US

(21) Appl. No.: 12/882,764

(22) Filed: Sep. 15, 2010

Related U.S. Application Data
(63) Continuation-in-part of application No. 12/620,851, filed on Nov. 18, 2009.
(60) Provisional application No. 61/311,580, filed on Mar. 8, 2010.
(60) Provisional application No. 61/115,874, filed on Nov. 18, 2008.
(60) Provisional application No. 61/270,942, filed on Jul. 15, 2009.

(51) Int. Cl. A61C 19/04

(52) U.S. Cl. 433/75

(57) ABSTRACT

A simple linking device configured to be positioned adjacent to an oral structure. The device provides a temporary positioning reference location that may be viewed in a tomography scan data set and surface scan data set. The dental device may be used to orient and verify the tomography scan data set and the surface scan data set to create a master dental file that may be used to determine the appropriate location of a dental implant.

### RELATED INVENTIONS

This application claims priority to U.S. Provisional Application No. 61/311,580 filed Mar. 8, 2010, and is a Continuation-in-Part of U.S. patent application Ser. No. 12/620,851 filed Nov. 18, 2009 which claims priority under 35 U.S.C. §119(e) from prior U.S. Provisional Patent Application Ser. No. 61/115,874 filed Nov. 18, 2008 and Ser. No. 61/270,942 filed Jul. 15, 2009. All of the foregoing applications are incorporated by reference herein in their entireties.

### FIELD OF THE INVENTION

The field of the invention relates to dental devices and procedures associated with various data sets from imaging and other sources of information with respect to a particular patient's physiology in physical and/or digital form and for linking data sets of information gathered regarding a particular patient's physiology into a comprehensive digital format for virtual design/illustration and manufacturing of image scanning templates, surgical guides, implants, crowns, bridges, and/or templates with optional diagnostic components useful in determining a suitable course of treatment for the particular patient.

### BACKGROUND

Physical master dental models can be of medical, dental damaged edentulous, partial edentulous, dentulous or other facial anatomical areas. Physical master dental models provide very valuable information about soft tissues and very detailed surface contours with relationship to the dental anatomy of teeth and/or tissue. This very important information of the soft tissue contours and relationship to the teeth and bones is typically not transferred accurately and mostly not transferred at all.

Making a traditional imaging template is very labor intensive with many steps. For example, a known template can be made with the following steps: Step (A): (1) 3D physical model; (2) waxing missing teeth by hand; (3) waxing tissue and other missing parts by hand; (3) duplicating wax up model with a silicone duplicating material; (4) separating the model from the silicone mold; (5) mixing a dental plaster and pouring it into the silicone mold; (6) waiting for it to harden one hour or so; (7) separating this new model from the silicone mold; (8) vacuum-forming a suck down onto this duplicated model; (9) trimming this plastic suck down (template); (10) mixing a barium powder into an acrylic mixture of powder and liquid; (11) pouring this mixture into the plastic suck down (template); (12) placing the first model together with the barium/acrylic filled template; (13) curing this in a warm water bath under vacuum; (14) separating the model from the cured acrylic (which almost always results in a broken model); (15) cleaning up the template; (16) fitting the template on to the master model (if the original master model was broken then a new master model needs to be reproduced, which can happen more then once during the process.) Step (B); any denture manufacture system can be used to create a template, which again takes a great deal of time and labor. This is only for making the imaging template. The template produced is scanned independent from and excluding any data transfer from the 3D physical model previously prepared.

A problem with computerized tomography (CT) scan images, cone beam computerized tomography (CB CT) scan images, magnetic resonance imaging (MRI) scan images, and other 3D imaging devise images is commonly referred to as “image scatter”. With CT scanning, different material in the patient's mouth can create what is called scattering of the image. This makes it difficult for the doctor to visualize teeth and bone contours, and basic anatomy, as well as any other anomalies, when analyzing the scanned image. Many times this scatter makes the imaging data unreliable, inaccurate and unusable for a proper diagnostic tool. An example of image scatter creating dental materials can include metal fillings, gold crowns and fixed partials.

One known attempt to eliminate these problems includes making a vacuum-formed plastic template from a duplicated diagnostic model. This template contains 3 mm-6 mm diameter balls of radio opaque material suitable for CT scan, CB CT scan, and/or MRI scan in several locations on the inside surface of the template. The patient wears this template in the mouth during a CT scan, CB CT scan, and/or MRI scanning process. The same template is placed back onto the 3D physical model in which it was made. The model is also subjected to a CT scan, CB CT scan, and/or MRI scanning process. Data relating to the outside surface of the template is all that is obtained from these two CT scans, CB CT scans, and/or MRI scans. The two different scanned data files are then put together with computer aided design (CAD) type software. The two scanned data file are connected by the 3 mm-6 mm diameter balls of radio opaque material suitable for CT scan, CB CT scan, and/or MRI scans in several locations on the inside surface of the template. The pictures are put together by the software. If the CT scan data, CB CT scan data, and/or MRI scan data has a lot of scatter, then this information is replaced with the scanned template outside surface data. CT scan data, CB CT scan data, and/or MRI scan data does not provide data as clean and as accurate as surface scan data.

It has been found that the vacuum-formed plastic template itself adds a layer of inaccuracy. The nature of the material allows the template to flex causing distortions when making and removing it from the working model. Placing the template into the patient's mouth can cause flexing, molding and stretching of the template shape, which can vary depending on the anatomical surfaces that it is in contact with, e.g. mouth contours, teeth, and tissue. Teeth are mobile and move small amounts in many different directions independent of each other because of the periodontal membrane. Tissue is both soft and hard in the mouth which can be distorted differently, when the same amount of pressure is applied to it. Teeth and tissue being mobile in nature, an inaccurate template can actual distort the actual position of teeth and tissue. A bad fitting template also will leave open spaces or gaps in between teeth, tissue, and/or the template. The thickness of the template itself will add another layer of inaccuracy to the data.

Other known ways of matching CT model scans can include a separate CT scan and model scan being virtually connected. Small areas of teeth and tissue from both scan data files are selected and matched together. This process is problematic if the CT image has scatter, since attempts to match areas or points from the model scan may not work.

### SUMMARY

The linking components can include one or more of the following features singularly or in any combination: (1) an anchor or receptor having an aperture to be fixedly connected to a dental master model; (2) a fastening connector component to be removably connected to the anchor or receptor for supporting at least one of an optional spacer and/or an imaging marker; (3) an optional spacer, if required to space an imaging template from the dental master model; and (4) a scaled and shaped imaging marker to reduce and/or eliminate information detail loss due to scatter using suitable radio opaque material in components, thereby allowing replacement of information lost with scan of model or patient's mouth to clean up CT scan data, CB CT scan data, and/or MRI scan data.

In a dental device for performing a dental procedure relating to replacement of teeth including a particular mouth formation of a patient and an intended dental implant location with respect to the patient, the improvement including a scaled and shaped linking component including an elongate fastening connector component and a shaped imaging/scaling marker component made at least partially of radio opaque material engageable with the elongate fastening connector component allowing at least one of a surface imaging scanning and a tomography imaging scanning of the at least one linking component creating an identifiable imaging scan data link.

In a dental device for performing a dental procedure relating to replacement of teeth including a particular mouth formation of a patient and an intended dental implant location with respect to the patient, the improvement including a linkable model, and at least one scaled and shaped linking component to be supported by the linkable model allowing surface imaging of the linkable model and linking component to create an identifiable imaging scan data link.

In a dental device for performing a dental procedure relating to replacement of teeth including a particular mouth formation of a patient and an intended dental implant location with respect to the patient, the improvement including a linkable imaging template, and at least one scaled and shaped linking component made at least partially of a radio opaque material to be supported by the linkable imaging template linkable with respect to a linkable model allowing a tomography imaging scan of physiology of the patient with the linkable imaging template and the at least one scaled and shaped linking component supported by the linkable imaging template to create an identifiable imaging scan data link.

A process for performing a dental procedure relating to replacement of teeth including a particular mouth formation of a patient and an intended dental implant location with respect to the patient, the improvement including scaling, orienting and aligning data from different data acquisition sources with respect to one another based on imaging of the at least one scaled and shaped linking component made at least partially of radio opaque material existing in the data from the different data acquisition sources, and linking the scaled, oriented, and aligned data from different data acquisition sources into a master data file.

In a dental device for performing a dental procedure relating to replacement of teeth including a particular mouth formation of a patient and an intended dental implant location with respect to the patient, the improvement including a diagnostic model formed with computer aided manufacturing using a master data file including linked, scaled, oriented, and aligned data from different data acquisition sources and including at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device for performing a dental procedure relating to replacement of teeth including a particular mouth formation of a patient and an intended dental implant location with respect to the patient made by a process including forming a diagnostic model with computer aided manufacturing using a master data file including linked, scaled, oriented, and aligned data from different data acquisition sources, and forming at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including a diagnostic model with at least one visualization portion of detailed bone/tissue anatomy formed on the diagnostic model selected from a group consisting of an exposed bone structure portion, a removable gum tissue portion, a removable bone structure portion, a root of a tooth, a root section contour of a tooth, bone density, an internal bone structure, a nerve channel, a major nerve, a major nerve ending, a tooth nerve, a tooth nerve ending, a tooth blood vessel, a tooth root canal, a tooth pulp canal, a blood vessel, an artery, and a sinus cavity.

A dental device defining a positive likeness of part of an oral cavity of a particular patient for constructing a finished dental prosthesis for use in at least one procedure selected from a group consisting of diagnosis, therapeutic treatment planning, and surgery relating to a human being, the dental device including virtually designing an imaging template with at least one linking component made at least partially of a radio opaque material, and printing the virtually designed template with a three dimensional printer.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1 is a simplified schematic diagram illustrating information linking mechanisms with linking components;

FIG. 2 is a perspective view of a linkable master dental model and impression having anchors and fastener connector components embedded in the master dental model and impression for linking the imaging components;

FIG. 3 is a detailed view of a linkable master dental model having apertures and linking anchors placed in the master dental model;

FIG. 4A is a perspective view of a plurality of between 3 mm-6 mm, inclusive, slotted, drilled, orientation ball and pin combinations associated with a hollow bone section diagnostic model;

FIG. 4B is a cross-sectional view of one of the between 3 mm-6 mm, inclusive, slotted, drilled, orientation ball and pin combinations associated with the hollow bone diagnostic model previously illustrated in FIG. 4A;

FIG. 5 is a side view of a set of linking components including a fastening connector component with scaling lines, an imaging/scaling marker, an optional spacer, anchor, imaging template, and dental model;

FIG. 6 is a side view of a set of linking components including a fastening connector screw, an imaging/scaling marker of radio-opaque material shaped as a sphere, an optional spacer, an anchor, an imaging template and a dental model;

FIG. 7 is a side view of a set of linking components including a fastening connector component, an imaging/scaling marker of radio-opaque material shaped as a tube in a variety of lengths, an optional spacer, an anchor, an imaging template, and a dental model;

FIGS. 8A-8C are illustrations of shaped mapping or linking pins made at least partially of radio opaque materials for use in CT scans, CB CT scans, and/or MRI scans and three-dimensional surface scanning or other scanning devices including positioning pins, orientation and/or scaling pins and radio opaque material pin tubes to be fit over the positioning pins, orientation and/or scaling pins with anchors;

FIGS. 9A-9B are a perspective views of a linkable imaging template formed on a linkable master dental model with fastening connector component and anchors;

FIG. 10A is a perspective view of a master dental model having an exposed underlying bone portion that can be covered by a removable tissue portion shown in FIG. 10B;

FIG. 10B is an exploded perspective view of a master dental model having a removable tissue portion removed to expose an internal removable bone structure portion;

FIG. 11 is a perspective view of a diagnostic model with bordered tissue and tissue veneer plus facial veneer diagnostic component;

FIG. 12A is a perspective view of a diagnostic model having an at least partially exposed bone portion and a facial veneer diagnostic component of an interior surface of teeth to be implanted;

FIGS. 12B-12C are perspective views of a diagnostic model having an at least partially exposed bone portion and a facial veneer diagnostic component of an exterior surface of teeth to be implanted;

FIG. 13A is a simplified cross sectional detail of a diagnostic model with exposed bone structure portion and visualization portions including a major nerve, an artery, a tooth nerve, a tooth blood vessel, a major nerve ending, a tooth root canal, a tooth pulp canal, a tooth root, a tooth nerve ending, bone density, and removable gum tissue; and

FIG. 13B is a simplified cross sectional side view of a diagnostic model with exposed bone structure portion, a removable gum tissue, and visualization portions including a tooth root, a tooth nerve, a tooth blood vessel, a main nerve, a main artery, a sinus cavity, a removable bone structure, and diagnostic teeth.

FIG. 14a illustrates an exemplary simple linking device.

FIG. 14b illustrates an exemplary marker.

FIG. 14c illustrates an exemplary marker.

FIG. 14d illustrates an exemplary marker.

FIG. 14e illustrates an exemplary marker.

FIG. 15 illustrates an exemplary simple linking device.

FIG. 16 illustrates an exemplary simple linking device.

FIG. 17 illustrates an exemplary simple linking device

FIG. 18 illustrates an exemplary simple linking device.

FIG. 19 illustrates an exemplary simple linking device.

FIG. 20 illustrates an exemplary simple linking device with adjustable clasping parts.

FIG. 20 illustrates a system of using a simple linking device of the type illustrate in FIGS. 14-20.

### DETAILED DESCRIPTION

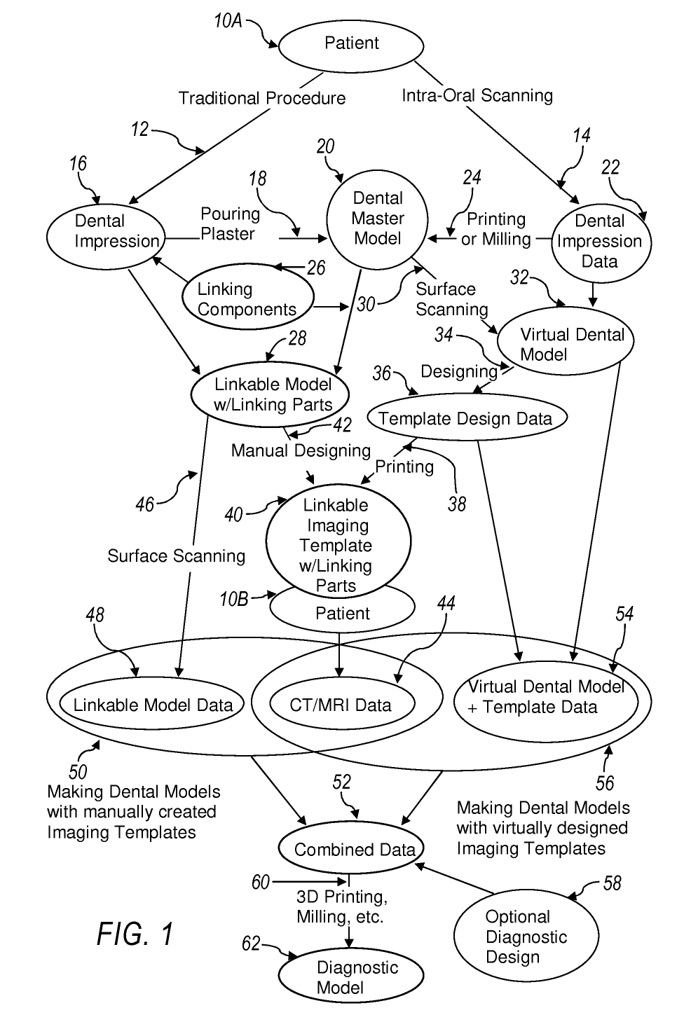

Referring now to FIG. 1, a simplified schematic diagram illustrating information linking mechanisms with linking components starts with a particular patient at a first point in time 10A undergoing either a traditional procedure 12 or an intra-oral scanning 14. The traditional procedure 12 includes a dental impression 16, pouring plaster 18 to create a dental master model 20. The intra-oral scanning 14 includes dental impression data 22, printing or milling 24 to create a dental master model 20. Linking components 26 can be associated with the dental impression 16 and the dental master model 20 to define a linkable model with linking parts 28. The linking components 26 can be used to create an identifiable imaging scan data link in common with both surface scan data files and tomography scan data files. The dental master model 20 can be surface scanned 30 to create a surface scan data file or the dental impression data can be inverted to provide a virtual dental model 32. Template design data 36 can be designed 34 with the virtual dental model 32. The template design data 36 can be used for printing 38 a linkable imaging template with linking parts 40. The linkable model with linking parts 28 can be used for manual designing 42 a linkable imaging template with linking parts 40. The linkable imaging template with linking parts 40 can be positioned in an oral cavity of the particular patient at a second point in time 10B to obtain tomography imaging scan data 44, by way of example and not limitation such as computerized tomography (CT) imaging scan data, cone beam computerized tomography (CB CT) imaging scan data, and magnetic resonance imaging (MRI) scan data, which are collectively referred to hereinafter generically as “tomography imaging scan data” 44. The linkable model with linking parts 28 including imaging/scaling markers can be surface scanned 46 to obtain a surface scan data file or linkable model data 48. The linkable model data 48 and tomography imaging scan data 44, collectively referred to as data sets 50, can be scaled, aligned, and oriented using the linking components 26 to create a combined data set 52 where dental models were made with manually created imaging templates. The virtual dental model 32 and the template design data 36 can be combined to provide virtual dental model+template data 54. The tomography imaging scan data 44 and virtual dental model+template data 54, collectively referred to as data sets 56, can be scaled, aligned, and oriented using the linkable imaging template with linking parts 40 printed 38 from the template design data 36 to create a combined data set or master data file 52 where dental models were made with virtually designed imaging templates. A master data file can be created from linked and scaled data from different data acquisition sources including at least one data acquisition source procedure selected from a tomography scan group consisting of CT image scanning the patient with a template having at least one scaled and shaped linking component, CB CT image scanning the patient with a template having at least one scaled and shaped linking component, MRI image scanning the patient with a template having at least one scaled and shaped linking component, and at least one data acquisition source procedure selected from a surface scan group consisting of intra-oral surface scanning the having at least one scaled and shaped linking component virtually placed on the data file, optical image scanning a linkable model having at least one scaled and shaped linking component, laser image scanning a linkable model having at least one scaled and shaped linking component, and surface scanning a linkable model having at least one scaled and shaped linking component. Optional diagnostic design data 58 can be incorporated into the combined data set or master data file 52. The optional diagnostic design 58 can include at least one of a fixed diagnostic component and a removable diagnostic component connected to the diagnostic model. The combined data set or master data file 52 can be used for three-dimensional (3D) printing or milling 60 of a diagnostic model 62 for performing a dental procedure relating to replacement of teeth including a particular mouth formation of a patient and an intended dental implant location with respect to the patient, where the diagnostic model 62 defines a positive likeness of at least part of an oral cavity of a particular patient for constructing a finished dental prosthesis for use in at least one procedure selected from a group consisting of diagnosis, therapeutic treatment planning, and surgery relating to a human being. The diagnostic model can be manufactured by three-dimensional printed structures made from a transparent material allowing internal three-dimensional printed structures corresponding to at least one of bone density, a root contour of a tooth, a nerve channels, a major nerve, a major nerve ending, internal bone structure, a tooth nerve, a tooth nerve ending, a tooth blood vessel, a tooth root canal, a tooth pulp canal, a blood vessel, an artery, and a sinus cavity to be made visible.

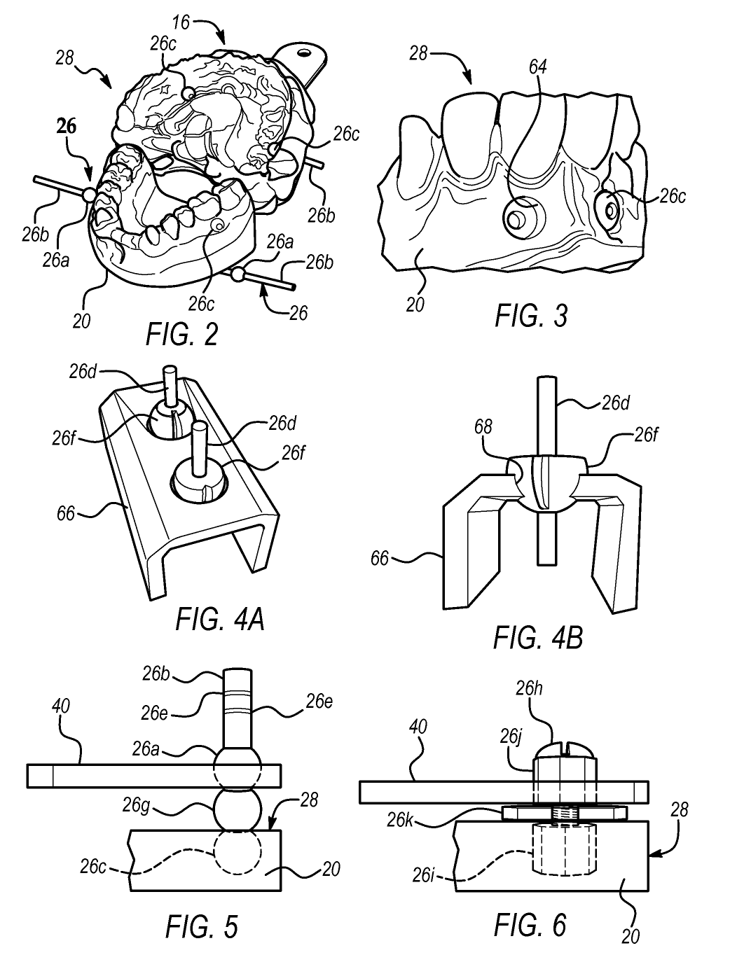

Referring now to FIG. 2, starting from a dental impression 16, a linkable model with linking parts 28, such as linking components 26, can be processed. The linking components 26 can include, by way of example and not limitation, anchors 26c and fastening connector components 26b placed within the dental impression 16 prior to pouring the model material into the impression to embed the anchors 26c within the linkable model with linking parts 28. Imaging/scaling marker 26a can be positioned on the fastening connector components 26b supported by the anchors embedded within the linkable model 28.

Alternatively, as illustrated in FIG. 3, starting from a dental master model 20, a linkable model with linking parts 28, such as linking components 26, can be processed. The dental master model 20 can be drilled subgingevally, lingually, facially or palatally in one or more locations. The diameter of the drilled apertures 64 corresponds with a diameter of desired anchors 26c. The linking components 26 can include, by way of example and not limitation, anchors 26c and fastening connector component 26b fixed within the drilled apertures 64 to embed the anchors 26c within the linkable model with linking parts 28.

Referring now to FIG. 5, a side view of a linking component including a fastening connector component 26b with scaling lines 26e is illustrated with a sphere-shaped anchor 26c embedded within a linkable model with linking parts 28. A radio-opaque imaging/scaling sphere-shaped marker 26a can be associated or fixed with respect to a linkable imaging template with linking parts 40. An optional spacer 26g can be located between an anchor 26c and an imaging/scaling sphere 26a, if desired.

Referring now to FIG. 6, a side view of a linking component including a fastening connector screw 26h is illustrated with a threaded anchor component 26i embedded within a linkable model with linking parts 28. A radio-opaque imaging/scaling marker component 26j can be associated or fixed with respect to a linkable imaging template with linking parts 40. An optional spacer 26k can be located between an anchor 26i and an imaging/scaling marker component 26j, if desired.

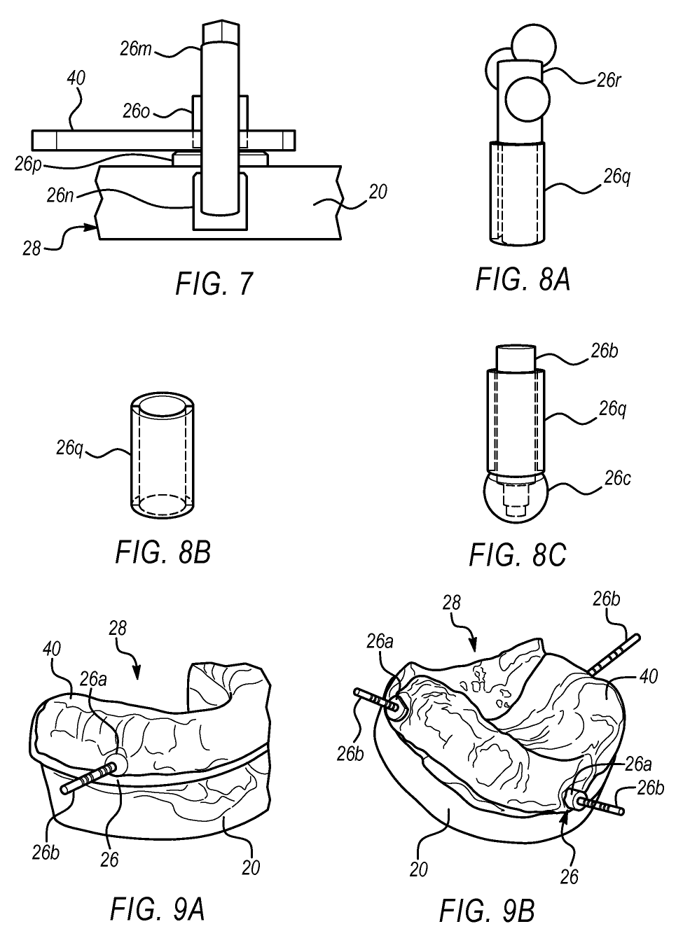

Referring now to FIG. 7, a side view of a linking component including fastener connector component 26m is illustrated with an anchor 26n embedded within a linkable model with linking parts 28. A radio-opaque imaging/scaling tube-shaped marker 26o can be made in a variety of lengths, and associated or fixed with respect to a linkable imaging template with linking parts 40. An optional spacer 26p can be located between an anchor 26n and an imaging/scaling marker 26o, if desired.

Referring now to FIGS. 8A-8C, by way of example and not limitation, an interchangeable cylindrical or tube shaped component 26q can be made of radio-opaque or non-radio-opaque material and used in combination with more complex shaped fastening connector component 26r made from radio-opaque or non-radio-opaque material for CT scanning, CB CT scanning, MRI scanning, or 3D surface scanning devices. The cylindrical component 26q can be supported by an orientation anchor 26c, or other anchor component such as those described above, and fastening connector component 26b combination with respect to a linkable model with linking parts 28. The anchor 26c and fastening connector component 26b can provide placement, angular orientation, and fixturing of the cylindrical component 26q with respect to a linkable imaging template with linking parts 40. After the cylindrical component 26q is removed from the fastening connector component 26b, a more complex shaped fastening connector component 26r can be supported within the interchangeable component 26q for 3D surface scanning devices.

Referring now to FIGS. 9A-9B, a linkable model with linking parts 28 is illustrated. All of the tissue area on the linkable model has been blocked out with a thin layer of block out material. Fastening connector component 26b can be inserted into corresponding anchors 26c. Radio-opaque imaging/scaling markers, by way of example and not limitation, such as markers 26a, 26j, 26n, 26o or 26q described in greater detail above, can be placed on the fastening connector component 26b for an imaging scan, such a 3D surface scanner to create a first imaging scan data set or surface scan data file. Tray material can be applied to the model embedding the radio-opaque linking components 26 to form a linkable imaging template with linking parts 40. The linking components 26 extend sufficiently outside of the imaging template to be exposed. Radio-opaque diagnostics can be placed on the model, and incorporated into the imaging template, if desired. The fastening connector components 26b can be removed from the cured imaging template and underlying model to allow the imaging template to be removed from the model and cleaned. Optionally, the cleaned imaging template can be repositioned on the model, and a 3D surface scan can be performed to create a surface scan data file of the imaging template, if linking components 26 are exposed sufficiently for surface matching to create a second imaging scan data set. The imaging template can then be sent to a doctor's office and positioned in the corresponding patient's mouth for another imaging scan to create a third imaging scan data set. Optionally, the imaging template alone can be subjected to an imaging scan to create a fourth imaging scan data set. The imaging scan of the patient with the imaging template in place can be selected from one or more of the following scans: a CT imaging scan of a physiology of the patient and imaging template, CB CT imaging scan of the physiology of the patient and imaging template, and MRI imaging scan of the physiology of the patient and imaging template. Scanned data can be sent or transferred between the doctor and/or technician as required using any suitable media or device or protocol. CT data files, CB CT data files, and MRI data files can be translated into a file format corresponding with 3D surface scanning data, or the data files can be converted into any compatible file format desired. After being translated into a compatible file format, the first, second, third, and optionally fourth data sets can be scaled, aligned, oriented and linked using the linking components 26 existing in each of the data sets.

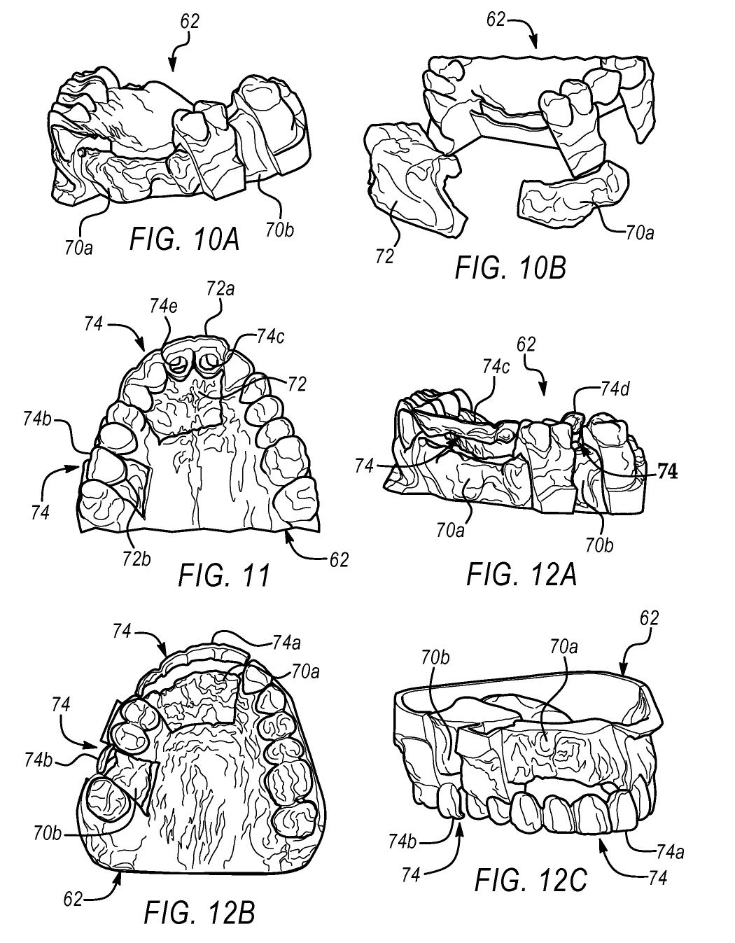

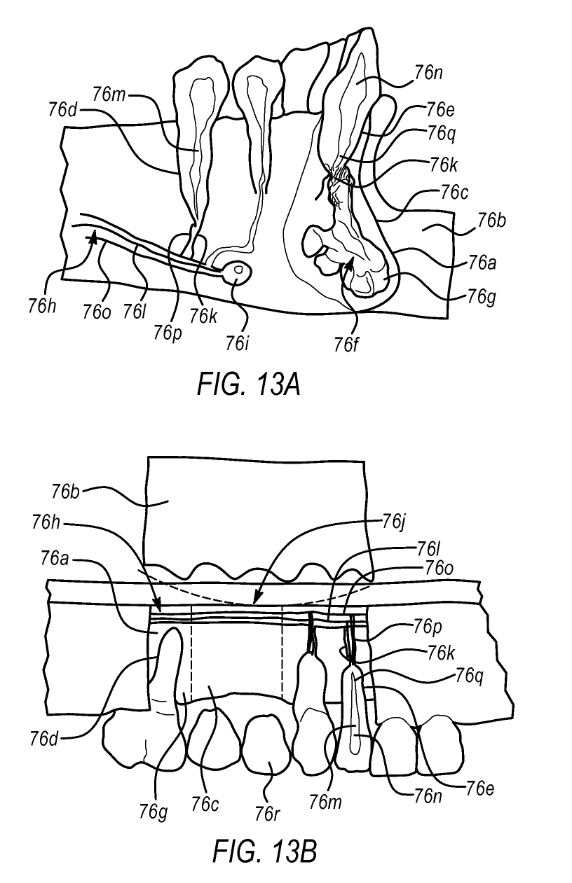

Referring now to FIG. 10A, a physical three dimensional (3D) diagnostic model 62 is illustrated with partially exposed bone structure portion 70a, 70b with or without a removable tissue portion 72, as shown in FIG. 10B. The 3D diagnostic model 62 can be made of solid color material, a transparent material, or a combination of different colors and/or a combination of different types of materials, by way of example and not limitation, such as hard materials, flexible materials, plastic materials, metal materials, ceramic materials, stone materials, or any combination thereof. Different combinations of transparent, opaque, and solid colored materials can be used when desired to make various physiology in a diagnostic model of a particular patient visible, i.e. providing a visualization portion 76 of detailed bone/tissue anatomy for the doctor or surgeon of a proposed treatment site including internal three dimensional printed structures, by way of example and not limitation, such as an exposed bone structure 76a, removable gum tissue 76b, removable bone structure 76c, a root of a tooth 76d, a root section contour of a tooth 76e, bone density 76f, internal bone structure 76g, a nerve channel 76h, a major nerve ending 76i, a sinus cavity 76j, a tooth blood vessel 76k, an artery 761, a tooth root canal 76m, a tooth pulp canal 76n, a major nerve 76o, a tooth nerve ‘76p, a tooth nerve ending 76q, diagnostic teeth 76r, and any combination thereof as shown schematically in FIG. 13A-13B. The 3D diagnostic model 62 can include an XYZ measurement scale placed in at least one location for verification of accuracy of the model. Information related to the case can be printed on the 3D diagnostic model 62, by way of example and not limitation, a doctor's name, a patient's name, an identification number, a case reference number, or any combination thereof. The 3D diagnostic model 62 can be created by different methods, by way of example and not limitation, such as computer numeric controlled (CNC) milling machines, and various types of 3D printers. When 3D printers are used to create physical three dimensional printed structures of the 3D diagnostic model 62, not only surface defects of the bone, but also porosity inside the bone cavity be visible by slicing the model 62 or coloring the porous area on transparent models. Depending on the quality of the CT/CB CT/MRI scan data bone density can be color coded also. By using a 3D printer, the 3D diagnostic model 62 can be printed along with an opposing model articulated properly with a functioning printed articulator, since 3D printers can print these components together or separately. In any case, the 3D diagnostic model 62 can include various types of fixed or removable diagnostic components as described in greater detail below.

Referring now to FIG. 11, a physical 3D diagnostic model 62 is illustrated with a diagnostic component 74, by way of example and not limitation, bordered tissue/tissue veneer diagnostic 72a, 72b and facial veneer diagnostic 74a, 74b. Diagnostic components 74 can be placed within and/or onto a 3D diagnostic model 62 and can include fixed diagnostic teeth, and/or fixed diagnostic tissue, and/or removable diagnostic teeth and/or removable diagnostic tissue. Diagnostic components 74 can be made by any suitable traditional process, by way of example and not limitation, such as diagnostic wax-ups, plastic or radio-opaque plastic diagnostic teeth duplicated from wax diagnostics. If desired, the plastic can be ultraviolet (UV) or white light cured plastic. Diagnostic components 74 can be made with precious, semi-precious, or non-precious metals. Diagnostic components 74 can be virtually designed separated from or incorporated within the 3D diagnostic model 62. The virtually designed diagnostic components 74 can be manufactured in conjunction with or separately from the 3D diagnostic model 62 by CNC milling machines, or various types of 3D printers. The diagnostic components 74 can be made of waxes, plastics, or various types of metal like traditional diagnostic components. By way of example and not limitation, diagnostic components 74 can include solid teeth, either connected to or separated from each other, veneers, such as facial veneers 74a, 74b illustrated in FIGS. 11, 12B, 12C or lingual veneers 74c, 74d illustrated in FIG. 12A, bordered tissue, tissue veneers, or different combinations of various veneers, either connected to or separated from each other. Diagnostic components 74 can also include lingual tissue or bordered tissue veneer designs, which can also be attached to a facial veneer, or layered onto the tissue material separated from the facial veneer. Hollow diagnostic component 74 designs, i.e. negative of solid shapes, connect to or separated from each other, can be printed within the material that is adaptable onto or with the 3D diagnostic model 62. Diagnostic components 74 can also include implants and all implant related components, by way of example and not limitation, such as different types of implant bars, abutments, and surgical guide designs. Implant diagnostic components 74 can be solid or hollowed out. Implant diagnostic components 74 can also have apertures 74e in the middle of the implant positions so that the pins 26b can be inserted to create a simple surgical guide, or can be created with pins 26b in the middle of the implant positions. Diagnostic components 74 can also include parts for orthodontics, parts for periodontics, parts for oral surgeons, parts for education, or any combination of the diagnostic components 74 discussed above.

Referring again to FIG. 12A, a physical 3D diagnostic model 62 is illustrated with at least partially exposed bone structure portions 70a, 70b and a diagnostic component 74, by way of example and not limitation, a lingual veneer diagnostic 74c, 74d. Diagnostic components 74 can be placed within and/or onto a 3D diagnostic model 62 and can be either fixed or removable. Tissue portions are not provided with this 3D diagnostic model 62, or if provided have been removed.

Referring again to FIGS. 12B-12C, a physical 3D diagnostic model 62 is illustrated with at least partially exposed bone structure portions 70a, 70b and a diagnostic component 74, by way of example and not limitation, a facial veneer diagnostic 74a, 74b. Diagnostic components 74 can be placed within and/or onto a 3D diagnostic model 62 and can be either fixed or removable. Tissue portions are not provided with this 3D diagnostic model 62, or if provided have been removed.

Referring now to FIGS. 4A and 4B, a plurality of diagnostic parts, by way of example and not limitation, such as between 3 mm-6 mm, inclusive, slotted, drilled, diagnostic orientation ball 26f and pin 26d combinations associated with a simplified, schematically drawn, hollow bone section 66 of a diagnostic model. The pin 26d is removable from the orientation ball 26f, and can be any desired configuration, by way of example and not limitation, such as press fit, snap fit, or threaded. The hollow bone section model 66 can be drilled subgingevally, lingually, facially or palatally in one or more locations to form an aperture 68 of a suitable diameter for a diameter of desired diagnostic orientation ball 26f and pin 26d combination. The orientation ball 26f allows angular orientation of an axis of the associated pin 26d prior to fixation with respect to the hollow bone section 66 of the diagnostic model. When properly positioned within the site for dental restoration, the orientation ball 26f and pin 26d combinations allow a simple surgical guide made on the diagnostic model for implant placement.

Linking components 26 can include (1) an anchor or receptor having an aperture to be fixedly connected to a dental master model; (2) a fastening connector component to be removably connected to the anchor or receptor at one end for supporting at least one of an optional spacer and/or an imaging marker; (3) an optional spacer, if required to space an imaging template from the dental master model; and (4) a scaled and shaped imaging marker to reduce and/or eliminate information detail loss due to scatter using radio opaque material suitable for various types of tomography scanning devices such as CT, CB CT, and MRI scanners, and also suitable for 3D surface scanning devices such as laser and optical scanners, thereby allowing replacement of information lost with scan of model or patient's mouth to clean up CT scan data, CB CT scan data, and/or MRI scan data through both image linking and physical linking. Linking components 26 can link imaging templates, dental models, tomography scan data, and surface scan data by creating more accurate visual markers with physically linkable parts where necessary. Imaging markers may have different geometric shapes for scaling and sizing, and usually made of radio-opaque materials for use with tomography scanning devices, such as CT scans, CB CT scans, MRI scans, and 3D surface imaging devices, such as laser scanners, optic scanners, and/or intra-oral scanners. Optionally, the physical linking components can include a non-radio-opaque surface marker component that is interchangeable with a radio-opaque imaging/surface marker, where physical linking and surface scanning data are desired, where radio-opacity will not be needed. A surface marker component contains at least some of the same geometric shape of an imaging/surface marker. When imaging markers are radio-opaque, dual function imaging/physical linking components 26 should be placed on areas where possible image scatters from existing metal crowns, post, etc. in the patient's mouth do not become the disturbance. For this reason, the dual function imaging/physical linking components should be commonly placed below the gum line, preferably at multiple locations, where the locations should be decided on a case by case basis. Radio opaque imaging tubes 26q, as a part of linking components 26, can be placed at possible locations of implants only when the patient does not have any metal crowns in the mouth where image scatter becomes a disturbance. For cases with metal crowns, another type of linking component 26, such as shorter tubes, small spheres, or other variation of shapes can be used in the area where disturbance from image scatter does not occur.

The functions of linking components 26 include the ability, by aligning the markers, to accurately link data from different sources of imaging devices, to clean distorted portions of data from CT/MRI/CB CT or other imaging devices by replacing the distorted portions of data with accurately aligned surface scan data. This function also allows users to replace less accurate CT/MRI/CB CT data with more accurate surface scan data in the area where more accuracy is needed for creation of dental restorations. The function of the linking components includes the ability to scale, size, align, orientate (XYZ co-ordinance), and verify the data from MRI, CT, CB CT and other imaging devices, as well as the data from optical (or laser) 3D surface scanning devices, or intra-oral surface scanning devices.

A virtually designed imaging template includes a data file containing dental model data, design of an imaging template created on the dental model data, and at least one imaging/surface marker design which location is also marked on the dental model data to create a linkable data file. A printed (or milled) virtually designed imaging template contains at least one imaging/surface marker or imaging/surface marker receptor site for the placement of an image/surface marker. Virtual generated 3D data can include CAD-CAM software and the artistic renderings from this software.

The dental device and method is a diagnostic device that accurately links a physical model to CT scan, CB CT scan, MRI scan information and/or optical scan information and/or laser scan information critical for proper diagnosis. Compared to the techniques currently used, the manufacturing process of this appliance is much simpler and faster, even though the appliance is more intricate.

The dental device and method has applications for dental and/or medical uses. By way of example and not limitation, the applications can include bridging or linking the following data: (1) 3D surface scanning data to CT scan, CB CT scan and/or MRI scan data; (2) 3D surface scanning data to CAD virtually generated 3D data; (3) CT scan, CB CT scan, and/or MRI scan data to CAD virtually generated 3D data; (4) CAD virtually generated 3D data to CAD virtually generated 3D data; and (7) in any and all combination of the aforementioned. The bridging or linking of data is for the purpose of diagnosing, treatment planning, educating, communicating, and accurately transferring data, either of a physical nature or an artistic nature, in digital or physical model form, and to any combinations of these types of information or data to the doctors, patients and technicians. The digital and/or physical model form data can also be transferred to the manufacturing facilities, allowing the manufacture of additional diagnostic tools and/or components, and to assist in the manufacturing of finished or partially finished prosthetics and/or prosthesis.

The dental device and method according to one embodiment of the invention, being able to accurately link and transfer these different groups of information—physical, CT scan, CB CT scan, MRI scan, and virtual computer aided design-computer aided manufacturing (CAD-CAM), makes possible faster manufacturing processes, that can help doctors and technicians communicate with accuracy and greater artistic abilities and more intricately produced prosthesis and prosthetics in a much faster time period than presently used techniques. This will also provide the patient and doctors with the most complete and accurate diversified package of information for their decision making process.

### Constructing a Linkable Model 28

Method 1. Starting from a dental impression, inspect and sanitize the dental impression received from the dentist. Drill holes through the impression material and the tray in one or more locations subgingivally, lingually, facially, or palatally. The diameter of the holes corresponds with the diameter of the fastener connector component. Insert the fastener connector component into the holes through the tray and the impression material. Place the linking anchors inside of the tray at the end of each fastener connector component. Make sure the anchor is touching the impression material. Fastener connector component and anchors are placed in the impression. Box in the dental impression with wax strips or other boxing materials, and pour the model material into the boxed impression. Remove the fastener connector component from the impression and the model when the linkable model 28 is cured and hardened. Separate the linkable model 28 from the impression. Clean and prepare the linkable model 28 in the traditional way. An anchor is embedded inside of the model. A linkable model 28 is provided with anchors, and fastening connector components and linking imaging/scaling marker components can be placed on the anchors.

Method 2. Starting from a dental master model 20, drill holes into the dental master model 20 subgingevally, lingually, facially or palatally in one or more locations. The diameter of the holes corresponds with the diameter of the anchors. Insert and secure the anchors into the holes of the dental master model 20. An anchor is fixed inside of the dental master model 20. A linkable model 28 is created with anchors, and fastening connector components and linking imaging/scaling marker components can be place on the anchors.

### Constructing a Linkable Imaging Templates 40 By Hand

Method 3: Starting from a linkable model 28 (made by either method 1 or method 2 above) construct the imaging template 40 by hand. Insert the fastening connector components into the anchors and place the additional radio-opaque linking imaging/scaling marker components on the fastening connector components. Different styles of linking components can be used, by way of example and not limitation, such as screw, snap, and friction fit, etc. Scan the linkable model 28 with the linking components including linking imaging/scaling marker components using the 3D surface scanner (data #1). Block out all the tissue area on the linkable model 28 with thin layer of block out material because of the tissue's flexibility in the patient's mouth. Make sure that there is no block out material on the linking anchors. Apply the tray material, by way of example and not limitation, such as ultraviolet (UV) light cured plastic, or light cured plastic, or thermal plastic to the model, and form the imaging template embedding the radio-opaque imaging/scaling marker in the material. Make sure that the radio-opaque imaging/scaling markers are somewhat exposed outside of tray. Optionally, radio-opaque diagnostics may be placed on the model, and incorporated into the template, if desired. Process the tray material according to the type of material used. When the tray material is fully cured and hardened, remove the fastening connector component and then the imaging template from the model. Clean the imaging template. Try the linkable imaging template back on the master model. 3D surface scanning can be also done at this point if linking components are exposed enough for surface matching (data #2). The imaging template is sent to the doctor's office, and tried in the patient's mouth. CT/CB CT/MRI (or other imaging devices) scanning is done with the imaging template in the patient's mouth (data #3). Optionally, the imaging template alone can be scanned by CT/CB CT/MRI (or other imaging devices) for the second time (data #4) if desired (it is not necessary for linking). Scanned data is sent to the doctor and/or the technician. Translate CT/MRI data files into the file format that corresponds with the 3D surface scanning data, and data #1 through #4 are now ready to be linked into a master data file.

### Constructing a Linkable Imaging Template By Virtual Designing From a Linkable Model

Method 4: Starting from a physical linkable model (made by either method 1 or method 2 above), and virtually constructing the linkable imaging template. Scan the linkable model to create a first data file (data #1). Scan the patients bite registration to create a second data file (data #2). Virtually block out all the tissue area on the virtual dental model because of the tissue's flexibility in the patient's mouth. Virtually design an imaging template that adapts to the solid structures (such as teeth or exposed bones) on the virtual dental model, incorporating the information from the bite registration scan data. Optionally, virtually design diagnostics into the imaging template, if desired at this point. Virtually design into the imaging template linking components so that anchors align with corresponding fastening connector components and corresponding imaging/scaling markers on the virtual dental model. The imaging/scaling marker components can be printed as radio-opaque solids along with the linkable imaging template or as hollowed out areas that will be filled with radio-opaque material after printing. The virtually designed imaging template with linking components defines a third data file (data #3). Send the design data (data #3) to a 3D printer, and manufacture the linkable imaging template. Clean the imaging template, and check it on the actual physical linkable model. The linkable imaging template is sent to the doctor's office, and tried in the patient's mouth. CT/CB CT/MRI (or other imaging devices) scanning is done with the linkable imaging template in the patient's mouth to create a fourth data file (data #4). Optionally, the linkable imaging template can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optional data #5) into a compatible file format that corresponds with the 3D surface scanning data files (data #1 and/or data #2), and data files #1 through #4 (and optionally #5) are now ready to be linked into a master data file. It should be noted that a physical linking component on the linkable model can be useful when the surface of the imaging template is altered later.

### Constructing a Linkable Imaging Template 40 (Without Linking Device on the Master Model) By Virtual Designing

Method 5: Start from an intra-oral scanning 14 data file, or dental impression data file after being inverted 22, or virtual dental model data file 32 to virtually construct the linkable imaging template 40. Any of the above data files or sets of data from intra-oral scanning 14, dental impression 22, or virtual dental model 32 can define a first data file (data #1). Scan the patients bite registration to define a second data file (data #2). Virtually block out all the tissue area on the virtual dental model 32 because of the tissue's flexibility in the patient's mouth. Virtually design an imaging template 36 that adapts to the solid structures (such as teeth or exposed bones) on the virtual dental model 32, incorporating the information from the bite registration scan data. Optionally, virtually design diagnostics into the imaging template, if desired at this point. Virtually design into the imaging template linking components so that align anchors align with fastening connector components and imaging/scaling markers on the virtual dental model 32. The imaging/scaling marker components can be printed as radio-opaque solids along with the linkable imaging template 40 or as hollowed out areas that will be filled with radio-opaque material after printing. The virtually designed imaging template with linking parts 40 defines a third data file (data #3). Send the design data (data #3) to a 3D printer, and manufacture the linkable imaging template 40. Clean the imaging template, and check it on an actual dental master model 20. The linkable imaging template 40 is sent to the doctor's office, and tried in the patient's mouth. CT/CB CT/MRI (or other imaging devices) scanning is done with the linkable imaging template 40 in the patient's mouth to create a fourth data file (data #4). Optionally, the linkable imaging template 40 can be scanned by itself with CT/CB CT/MRI (or other imaging devices) for the second time to create a fifth data file (data #5), if desired since this data is not necessary for linking. Scanned data is sent to the doctor and/or the technician. After translating the CT/CB CT/MRI data files (data #3, data #4, and/or optionally data #5) into a compatible file format that corresponds with the 3D surface scanning data files (data #1 and/or data #2), and data files #1 through #4 (and optionally #5) are now ready to be linked into a master data file.

Suitable equipment for any of the products, methods and processes described above is commercially available. By way of example and not limitation, suitable 3D prototyping printers are commercially available, such as sold under either the EDEN series or CONNEX series (for multi-material 3D prototype printing) by Objet Geometrics, Inc. having an office in Billerica, Mass. and a headquarters located in Rehovot, Israel, or such as sold under FORTUS 3D Production Systems by Stratasys, Inc. having headquarters located in Eden Prairie, Minn. By way of example and not limitation, suitable colored and translucent materials are commercially available under tradenames such as FULLCURE material or VERO material sold by Objet Geometrics, Inc. having an office located in Bellericda, Mass. and a headquarters located in Rehovot, Israel, or under the tradenames ABSi material, or ABS-M30i material, or PC-ISO material sold by Stratasys, Inc having headquarters located in Eden Prairie, Minn. By way of example and not limitation, suitable radio opaque materials are commercially available under tradenames such as VIVO TAC materials or ORTH TAC materials sold by Ivoclar Vivadent AG having an office in Amherst, N.Y. and a headquarters in Schaan, Liechtenstein. By way of example and not limitation, suitable computer numeric controlled (CNC) equipment is commercially available, such as sold under either the VR series or VF series CNC equipment by Haas Automation, Inc. located in Oxnard, Calif., or such as sold under either the MCD series or the MAG series, or the V series by Makino, Inc. located in Tokyo, Japan. By way of example and not limitation, suitable software is commercially available, such as CT/MRI 3D view & STL translation software sold under the name MIMICS by Materialise MGX located in Leuen, Belgium, or sold under the name INVIVO DENTAL by Anatomage, Inc. located in San Jose, Calif.; or sold under the name SCANIP by Delcam, PLC located in Birmingham, UK. By way of example and not limitation, suitable software is commercially available, such as modeling/designing software sold under the name GEOMAGIC STUDIO by Geomagic, Inc. located in Research Triangle Park, N.C., or sold under the name COPY CAD, POWER SHAPE, ART CAM by Delcam, PLC located in Birmingham, UK. Each of these commercially available products can be used in any combination, subject to the manufacturer's recommendations for combining materials and prototyping printer models, to manufacture the products or practice the methods and processes described in greater detail above.

However, under certain conditions, the need to create a custom imaging template from a digital diagnostic model or a physical diagnostic model, as discussed above, may be unnecessary. Such conditions may arise when a patient is fitted with at least one simple linking device. The simple linking device may be used to link data from a tomography scan and a surface scan in order to create a master data file that may be used to determine the ideal location for a dental procedure including insertion of a dental implant. Reducing the need to make the custom imaging template may result in time savings, cost savings, and fewer visits to the dentist.

Although described with respect to implant surgeries, the following dental device, method, and system can be used in conjunction with other oral procedures and diagnosis including, but not limited to, bone grafting and maxillofacial reconstruction.

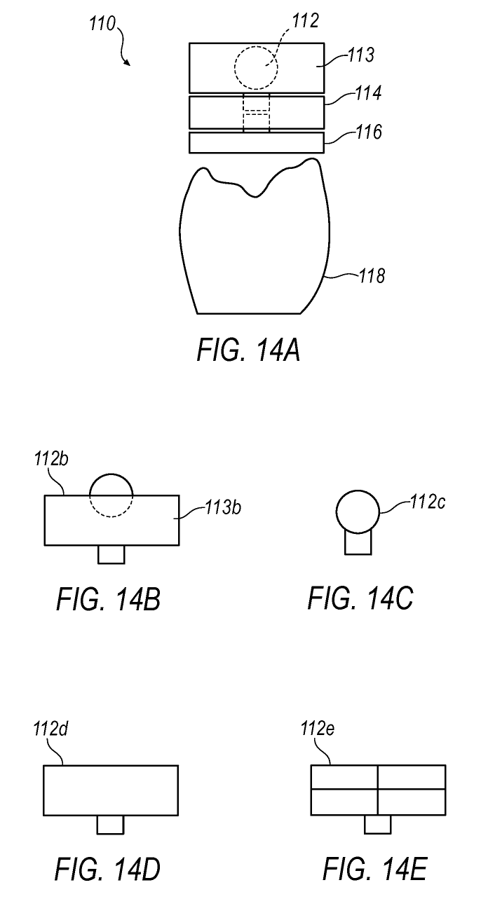

FIG. 14a illustrates an exemplary simple linking device 110 configured to contact a portion of an upper surface of an oral structure. The simple linking device 110 may take many different forms and include multiple and/or alternate components. While an exemplary simple linking device 110 is shown in FIG. 14a, the exemplary components illustrated in the figure are not intended to be limiting. Indeed, additional or alternative components and/or implementations may be used.

The simple linking device 110 may include at least one marker 112, an extension member 114, and a dental anchor 116. As illustrated in FIG. 14, the marker 112 is substantially spherical and may be embedded in a housing 113. However, the marker 112 may be designed as any geometric shape or combination of geometric shapes suited to fit the contours of a mouth and capable of being viewed in a tomography scan and/or a surface scan. For example, the marker 112 may be configured to be substantially rectangular, as illustrated in FIGS. 14d and 14e, substantially cubical, or substantially cylindrical. The marker 112 also may also be used without housing 113 as illustrated in FIG. 14c.

The marker 112 may be formed from a radio-opaque material, a non radio-opaque material, or a combination thereof. The radio-opaque material may be a thermoplastic, a ceramic, or any other suitable material, or any suitable combination of materials capable of inhibiting electromagnetic radiation. As previously discussed, this allows the marker 112 to be viewable during CT scans, CB CT scans, CB VT scans, MRI scans, and other types of three-dimensional tomography scanning. The marker may also be viewable in surface scans.

In some instances, the marker 112 may be formed from a non radio-opaque material. As a non-limiting example, the marker 112 may be formed from a non radio-opaque material when the marker 112 is configured to be interchangeable with a radio-opaque marker or when a plurality of markers, including at least one radio-opaque or radio-lucent marker, is positioned in a mouth. The non radio-opaque material may be a plastic or any other suitable material that allows electromagnetic radiation to pass through the marker 112 substantially uninhibited.

The marker 112 may also be a radiodensity comparative reference marker. Radiodensity comparative reference markers may be formed using various chemical compositions. This allows the marker 112 to have a different radiodensity based on the chemical composition that is selected. Although an exemplary reference marker 112 is shown, the reference marker may take on any suitable configuration. Additionally, a single multiple radiodensity marker 112 may be used in the simple linking device 110 or a plurality of reference markers may be used. In one exemplary simple linking device, illustrated by FIG. 14e, the plurality of markers 112 may be reference markers of various radiodensity.

One benefit of using radiodensity comparative reference markers is that the accuracy of the tomography scan data may be evaluated using such markers. For example, CT scans or MRIs create a series of two dimensional pictures that may vary in accuracy depending on whether or not the machine is properly calibrated. When reconstructing tomography scan data into three dimensional images, often done with volumization software, a threshold value of grey scale radiodensity may be quantified using a Hounsfield Unit (HU). However, the software threshold value may not be consistent with the threshold value indicated in the scan data file, since each read out of the scan data may be affected by one or more factors such as the calibration of the scanner, the method of image acquisition, the computer software being used, or image scatter. However, the use of a radiodensity comparative reference marker may provide a “built-in” standard. That is, the operator may use a radiodensity comparative reference marker with a known density as a reference to tune the threshold setting of the software for volumization of the data file. This standard may give users a tool to evaluate the tomography data file and to create more accurate bone models.

Another benefit of using radiodensity comparative reference markers is that the reference marker may be used to mimic various degrees of bone density during a tomography scan. Therefore, a radiodensity comparative reference marker with a known density may be used as a reference to tune the threshold settings of the volumization software. This may provide a model with a more accurate representation of a patient's bone density. As mentioned above, the condition of patent's bone density can affect the success of a dental treatment. This is especially true with respect to the placement of a dental implant.

Another exemplary marker 112 that may be used with the simple linking device 110 is a negative marker. By designing a cavity or other similar structure of a certain size and geometric shape into the simple linking device 110 a negative linkable marker can be created. This cavity, which is substantially devoid of material, will appear as a geometric shaped black space in the tomography scan data of a patient when the threshold density is set at the same radiodensity density level as that of the marker 112 and/or marker housing 113. This density level may be the density level of skin. The negative marker may also increase the accuracy of the tomography scan data because the empty space will offer the clearest image of the marker outline without distortion.

The marker 112 may be supported by an extension member 114. The marker 112 may be integral with the extension member 114 or the marker 112 may be releasably engagable with the extension member 114. If releasably engagable, the marker 112 may be engaged with the extension member 114 in any suitable manner including, but not limited to, snapping, screwing, bolting, and sliding. The marker 112 may also be releasably engagable in a manner that substantially prevents the marker 112 from moving during a tomography scan and/or surface scan. It is paramount that the marker 112 maintains its size, shape and positioning during the tomography scan and/or surface scan so that the marker 112 may be used to accurately link data from the scans.

An exemplary extension member 114 is illustrated in FIG. 14a as a rectangular member. However, the extension member 114 may be formed as any suitable geometric shape or combination of geometric shapes suited to fit the contours of a mouth and capable of supporting the marker 112 or a plurality of markers during a tomography scan and/or surface scan. Some examples may include, but are not limited to, a substantially cylindrical member or a substantially cuboidal member.

The length of the extension member 114 may be selected based on the dimensions of a mouth or the size of an oral structure 118 where the simple linking device 110 may be positioned. The oral structure 118 may be, but is not limited to, a tooth, an exposed root, a pre-existing prosthesis, or any other structure capable of supporting the extension member 114 and at least one of the marker 112 during a tomography scan and/or surface scan.

The extension member 114 may be formed from any suitable material that is safe to use during an oral procedure and capable of supporting the marker 112 or a plurality of markers. The extension member 114 may be formed from a non radio-opaque material or any other material that does not cause too much noise or scatter in tomography scan data. The extension member 114 may also be formed of a material having a different radiodensity then the oral structure 118 and the marker 112 or at least a portion of the marker 112 supported by the extension member 114.

The extension member 114 may also be formed from a material having a first phase that is substantially flexible upon positioning in a mouth, but maintains rigidity during the tomography scan and/or surface scan. Such materials may include, but are not limited to, a light curable composite and a low temperature thermal plastic. Light curable composites and low temperature thermal plastics are generally flexible prior to being cured or cooled to the human body temperature, respectively. This substantially flexible material may allow a dentist or technician to contour the simple linking device 110 to the features of a mouth, creating a device designed to respond to the unique oral structures of a patient.

Once the dentist is satisfied with the positioning of the simple linking device 110, the material may be cured or cooled. This causes the simple linking device 110 to become substantially rigid, thus maintaining the size, shape and position of the device. As noted above, it is paramount that the marker 112 maintains its size, shape and positioning during the tomography scan and/or surface scan so that the marker 112 can be used to scale, orient, and align data from the scans, discussed in more detail below.

Also as illustrated in FIG. 14a, the extension member 114 may be connected to a dental anchor 116. The dental anchor 116 may be integral with the extension member 114 or the dental anchor 116 may be releasably engagable. If releasably engagable, the dental anchor 116 may be engaged with the extension member 114 in any suitable manner.

FIG. 14a also illustrates an exemplary dental anchor 116 comprised of a substantially rectangular member releasably engaged with the extension member 114. However, the dental anchor 116 may be formed as any suitable geometric shape or combination of geometric shapes suited to fit the contours of an oral structure 118 and capable of supporting the extension member 114 and the marker 112 during a tomography scan and/or surface scan. Some examples may include, but are not limited, a substantially spherical member or a substantially cuboidal member. Although illustrated as contacting the occlusal surface of a tooth, the dental anchor may be configured to contact an upper surface of any suitable oral structure.

Similar to the extension member 114, the dental anchor 116 may be formed from any suitable material that is safe to use during an oral procedure and capable of supporting the extension member 114 and at least one marker 112. The dental anchor 116 may be formed from a non radio-opaque material or any other material that does not cause substantial noise or scatter in tomography scan data. The dental anchor 116 may also be formed of a non-radio opaque material having a different radiodensity then the oral structure 118 and the marker 112 or at least a portion of the marker.

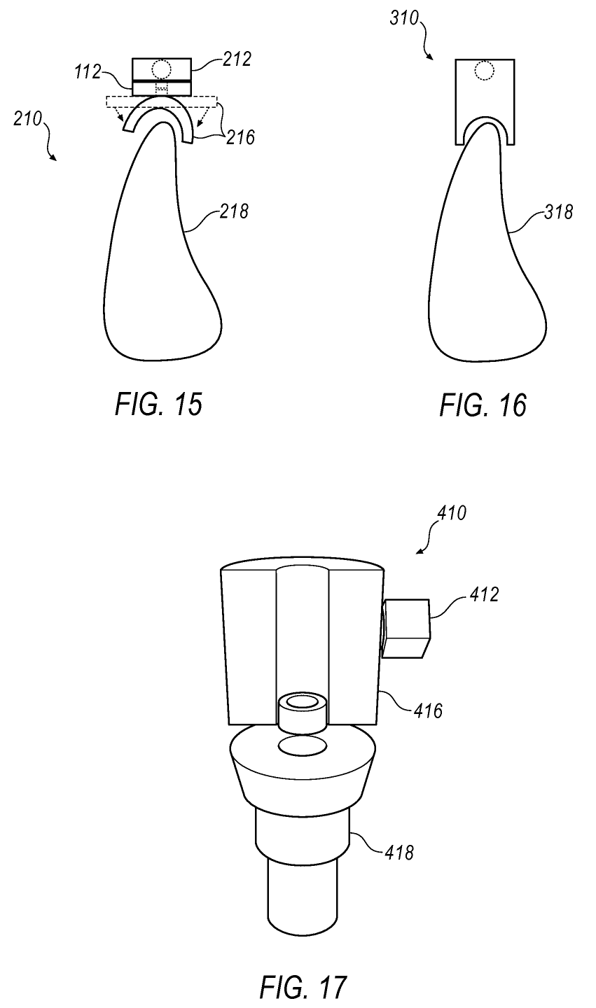

As illustrated in FIG. 15, the dental anchor 216 may also be formed from a material that is substantially flexible upon positioning in a mouth, but maintains rigidity during the tomography scan and/or surface scan, as illustrated by the dashed and solid lines. Such materials may include, but are not limited to, a light curable composite and a low temperature thermal plastic as discussed above. The use of this type of material may allow the device 210 to be positioned in a mouth and contoured to an oral structure 118, but also allows the device 210 to maintain rigidity during the tomography scan and/or surface scan.

As illustrated in FIGS. 14 and 15, the dental anchor 116, 216 may be positioned adjacent to the oral structure 118. The dental anchor 116, 216 may also be releasably securable to the oral structure 118. The dental anchor 116, 216 may be releasably securable using a UV cured or light cured composite, a cement, a wax, a dental compound, a thermal glue, or any other suitable adhesive, bonding, or glue-like material. The dental anchor 116, 216 may also be positioned adjacent the oral structure 118 using a bracket or any other suitable method of attachment.

The components of the simple linking device illustrated in FIGS. 14 and 15 may be formed as a single piece or, for example, the marker 112, the extension member 114, and the dental anchor 116 may be separate pieces. If separate, the marker 112, the extension member 114, and the dental anchor 116 may be assembled in the mouth or prior to positioning in mouth.

FIG. 16 illustrates another exemplary simple linking device 310 including at least one marker 312. As illustrated in FIG. 16, the simple linking device 310 may be formed as a single piece or the device may be formed from a plurality of pieces assembled together. The simple linking device 310 may be formed of a substantially rigid material that does not change its configuration while positioned in a mouth.

FIG. 17 illustrates another exemplary simple linking device 410 including a dental anchor 416 and at least one marker 412. As illustrated, the dental anchor 416 is snapped onto an exposed implant 418. However, the dental anchor 416 may be releasably securable to any other suitable structure capable of supporting the simple linking device 410 during a tomography scan and/or surface scan. The dental anchor 416 may be releasably securable using a UV cured or light cured composite, a cement, a wax, a dental compound, a thermal glue, or any other suitable adhesive, bonding, or glue-like material. The dental anchor 416 may also be positioned adjacent the oral structure 418 using a bracket or any other suitable method of attachment.

The marker 412 may be positioned adjacent to the dental anchor 416. The marker 412 may be positioned using a cement, a wax, a dental compound, a thermal glue, or any other suitable adhesive, bonding, or any other suitable securing material. The marker 412 may also include a marker positioning face (not shown) having an adhesive layer or an adhesive surface configured to position the marker 412 adjacent to the dental anchor 416. The marker 412 may also be positioned adjacent to the dental anchor 416 using a bracket or any other suitable method of attachment. The marker 412 may be positioned adjacent to the dental anchor 416 either before or after the dental anchor 416 is positioned with respect to the oral structure 418. The marker 412 may also be integral with the dental anchor 416.

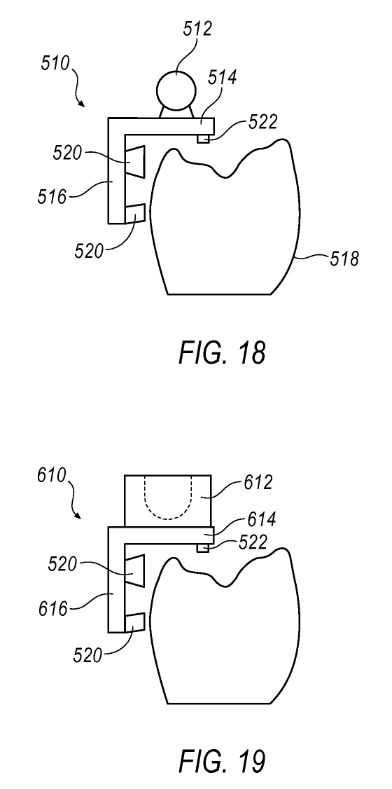

FIG. 18 illustrates another exemplary simple linking device 510 including an extension member 514, a dental anchor 516 and at least one marker 512 positioned adjacent to the extension member 514. In FIG. 18, the extension member 514 and the dental anchor 516 are configured to be substantially L-shaped and are positioned adjacent to an oral structure 518. The oral structure 518 may be a tooth, an exposed root, a pre-existing prosthesis, or any other structure capable of supporting the simple linking device 510 during a tomography scan and/or surface scan. Although illustrated as L-shaped, the extension member 514 and the dental anchor 516 may take on any shape suited to fit the contours of a mouth and capable of supporting the marker 512 or a plurality of markers. The extension member 514 and the dental anchor 516 may be formed from a single piece or the extension member 514 and the dental anchor 516 may be an assembly of pieces. Similarly, the marker 512 may be formed integrally with the extension member 514 or the marker 512 may be formed separately and secured to the extension member 514. In another exemplary linking device, marker 512 may be formed integrally with the dental anchor 516 or formed separately and secured to the dental anchor 516.

The dental anchor 516 may include at least one protrusion 520. The protrusion 520 extends inwardly from the dental anchor 516 toward an oral structure 518. The protrusion may also be configured to extend inwardly from the extension member 514. The protrusion 520 may be used to retain a UV cured or light cured composite, a cement, a wax, a dental compound, a thermal glue, bonding, or any other material suitable for releasably securing the dental anchor 516 to the oral structure 518. As illustrated in FIG. 18, the simple linking device 510 may also include at least one occlusal rest 522. The occlusal rest 522 may extend inwardly from the extension member 514 toward the oral structure 518.

FIG. 19 illustrates another exemplary simple linking device 610 including an extension member 614, a dental anchor 616 and at least one marker receptor 612 positioned adjacent to the extension member 614. The simple linking device 610 is similar to simple linking device 510, except for the addition of marker receptor 612. The marker receptor 612 may be configured to receive any of the markers described above and it may also be used as a negative marker. The marker receptor 612 may be integral with the extension member 614 or the marker receptor 612 and the extension member 614 may be formed separately and assembled inside a mouth or prior to insertion into a mouth. In another exemplary device, marker receptor 612 may be positioned adjacent to the dental anchor 616.

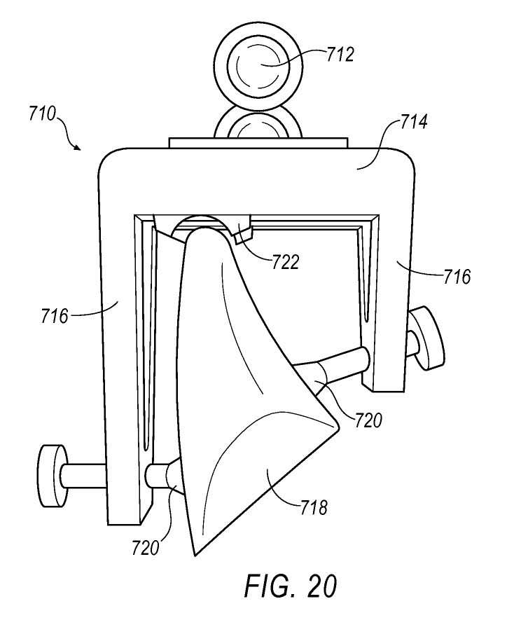

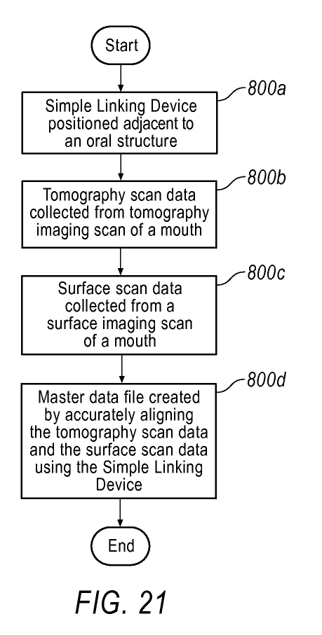

FIG. 20 illustrates an exemplary simple linking device 710 with adjustable clasping parts. The simple linking device 710 includes an extension member 714, a dental anchor 716 and at least one marker 712 positioned adjacent to the extension member 714. In FIG. 20, the extension member 714 and the dental anchor 716 are illustrated as substantially U-shaped, however, additional shapes and configurations may be suitable. The extension member 714 and the dental anchor 716 are configured to be positioned adjacent to an oral structure 718. The oral structure 718 may be a tooth, an exposed root, a pre-existing prosthesis, or any other structure capable of supporting the simple linking device 710 during a tomography scan and/or surface scan. The dental anchor 716 is releasably securable to the oral structure 718 using at least one clasping part 720. The clasping part 720 may be adjustable to allow the dental anchor 716 to be releasably secured to oral structures of various sizes.

FIG. 20 illustrates the dental anchor 716 having two clasping parts 720. As illustrated, the dental anchor 716 is disposed adjacent to an oral structure 718. The clasping parts 720 may be adjusted until they make contact with the oral structure 718. As a non-limiting example, the clasping part 720 may be screws or bolts that are tightened until they make contact with the oral structure 718. Thus, the clasping parts 720 may stabilize the dental anchor 716 to prevent movement of the at least one marker 712 during a tomography and/or surface scan. As illustrated in FIG. 20, the dental simple linking device 710 may also include a rest 722 extending inwardly from the extension member 714. The rest 722 may contact an outer surface of the oral structure 718 and stabilize the simple linking device 710.

FIG. 21 illustrates an exemplary approach for using any of the exemplary simple linking devices to select a surgical site or to perform other dental procedures including determining locations for dental implants. As shown in block 800a and discussed above, at least one simple linking device may be positioned in a mouth. Prior to positioning, the dentist may examine the oral structures to determine the best location for the simple linking device. The decision of where to position the simple linking device may be based on, but is not limited to, the type of oral structures present, the condition of the oral structures, and the location of the oral structures generally or with respect to a potential implant site. Once positioned, if the extension member and/or anchor is comprised of a substantially flexible material such as, but not limited to, a light curable composite or a low temperature thermal plastic, the simple linking device may be contoured to the features of the mouth. The simple linking device may then be cured or cooled to form a rigid device.

As shown in block 800b and as discussed above, after the simple linking device 110, 210, 310, 410, 510, 610, 710 is positioned, and cured or cooled if necessary, a tomography scan of the mouth may be performed. The tomography scan may be performed using a CT, a CB CT, a CB VT, an MRI, or any other suitable imaging device. Multiple tomography devices may also be used to create different types of tomography images if desired. The data collected from the tomography scan or scans, including the orientation and positioning of the simple linking device may be used to create a tomography scan data set.

As shown in block 800c and discussed above, a surface scan of the mouth including the simple linking may also be performed in order to create a surface scan data set. The surface scan data may be collected by performing an intra-oral surface scan of the mouth. The surface scan data may also be collected by performing an optical image scan, a laser image scan or any other type of surface scan of a dental model that is created from a dental impression of a mouth, which includes the orientation and positioning of the simple linking device as well as any other oral structures present on the outer surface of the gum tissue and inside the mouth.

If an impression is taken with the simple linking device positioned in the mouth, the general location of the simple linking device will be preserved in the impression. The original simple linking device or a simple linking device of same size and shape may be placed in or on the dental impression in a position that corresponds to the device previously positioned in the mouth. The impression may be boxed in with wax strips or other suitable boxing material so that the model material may be poured into the boxed impression, forming a physical diagnostic model. The physical diagnostic model which includes at least one embedded simple linking device may be surface scanned to obtain the surface scan data set.

An impression may also be taken with only certain components of the simple linking device. As an example, with respect to FIG. 14a, the marker 112 and/or the extension member 114, may be removed from the simple linking device prior to taking the impression. The anchor or a component of the same shape may be placed in or on the dental impression in a position that corresponds to the location where the components was previously positioned in the mouth. After the dental model has hardened the removed components of the anchor or components of the same size and shape may be placed in the dental model. If the shapes of extensions were changed from the original design of the device, it is paramount to use the same components in the dental model that were used in the tomography scan. A physical dental model may then be formed, as described above.

After the tomography scan and surface scan have been performed, the tomography scan data set and the surface scan data set may be aligned to create a combined master data file. To create the combined master data file the tomography scan data may first be analyzed using tomography data volumalizing and converting software. As discussed above, volumalizing software is used to reconstruct two dimensional pictures into three dimensional images. When analyzing the tomography scan data, the data set may represent various structures of the mouth. However, in some situations it may be beneficial to segment different portions of the scan to create digital models that represent individual sections of an oral structure. For example, the tomography scan data set may be segmented into portions representing the jaw bone, teeth, roots, nerves, etc. If the simple linking device previously inserted into the mouth of the patient has at least one radiodensity comparative reference marker, as discussed above, the marker may be used to verify the accuracy of the original scan data and/or as a reference to create models of individual sections of an oral structure. Once the tomography scan data has been volumalized and its accuracy verified, the data may be converted to CAD (computer aided drafting) compatible data and exported to a modeling system or any other suitable system for appropriate analysis and manipulation. Such system may include hardware, software or a combination of software and hardware.

As shown in block 800d and discussed above, after translating the tomography scan data set into a file format that corresponds with the surface scan data set, the tomography scan data and the surface scan data may be linked to create a master data file. That is, the presence of at least one simple linking device including at least one marker in the tomography scan data set and a corresponding simple linking device and marker in the surface scan data set provides a temporary positioning reference location in each data set. These corresponding temporary positioning reference locations enable accurate linking of the data sets because the reference locations present in both scan data sets can be aligned. Thus, the master data file will contain an accurate representation of an entire mouth—the tomography scan data provides imaging of the structures underneath the gum tissue including bone density information and the surface scan data provides imaging of the surface structures of a mouth including oral structures. The master data file may be used for evaluation of potential locations for dental procedures or to create digital or physical diagnostic model.

The linked data from the tomography scan and the surface scan may also be used to verify the scaling and sizing of the data contained within the tomography scan data set and the surface scan data set. Verifying the scaling and sizing of the data is important when precise implant placement is paramount due to the type of implant needed. One way to verify the scaling and sizing of the scanning images is to compare the known size and shape measurements of the simple linking device to the size and shape measurements of simple linking device as it appears in the scanning images.

However, a digital design of the simple linking device, including the marker may also be used to align the tomography scan data and surface scan data. A digital design of the linking device may be provided when the simple linking device is received or a digital design of the device may be created by surface scanning the simple linking device. The digital design may then be used to identify the complete structure of the marker in both the tomography scan data set and the surface scan data set in order to accurately align the two data sets. Using the digital design may increase the accuracy of alignment by identifying areas of the marker that may be obstructed in either the tomography scan and/or the surface scan. For example, the outline of a radio-opaque marker may be viewable in the tomography scan data. However, the outline of the entire simple linking device may be only partially detectable depending on the type of material used. As another example, the surface scan data set may provide an outline of the outer surface of the simple linking device, but it will not represent the internal structure of a marker nor will it represent the bottom area of the marker that may abut the surface of an oral structure. Given scatter and other types of inaccuracies in the data, simply aligning the outline in the tomography scan data set to the outline in the surface scan data set may not accurately represent the location of oral structures within the mouth in some cases. However, aligning the tomography scan data set and the surface scan data set to the digital design may provide a more accurate representation.

In one exemplary approach, the digital design may be aligned with or superimposed over the surface scan data set to indicate the location of any hidden structures not represented in the surface scan data set. For example, superimposing the digital design over the outline of the simple linking device in the surface scan data may provide a representation of where the marker and/or simple linking device abut an oral structure. Such areas if located underneath the device and/or marker would not be viewable in a surface scan of the mouth. The digital design could then be used to align the surface scan data set to the tomography scan data set using an outline of the device detectable in the tomography scan data. For alignment, the tomography scan data set and the surface scan data set do not have to have a common plane. Instead, each image can be oriented according to the digital design of the device. Although one exemplary approach for aligning the scan data sets is provided other approaches for aligning the data using the digital design may be used. For example, the digital design may first be aligned with the tomography scan data set or the digital design may be used to simultaneously align the data sets. Additionally, the digital design may be used to align more than just two data sets.

The digital design of the simple linking device may also be used to verify the scaling and sizing of the data contained within the tomography scan data set and the surface scan data set. Verifying the scaling and sizing of the data is important when precise implant placement is paramount due to the type of implant needed.

Use of the digital design also allows for numerous additional design options for the dental device and the marker. For example, a simple linking device may be designed with a marker entirely or partially enclosed in an external structure. Although a entirely or partially enclosed marker may not be fully detectable in a tomography scan data set and/or a surface scan data set, the marker would be visible when the data sets were aligned using the digital design.

After the data sets have been aligned to create a combined master data file, using either a marker and/or digital design, the master data file can then be used for evaluation or to create a digital or physical diagnostic model that contains accurate bone structure 109 and tissue 107 representations. Diagnostic designs including teeth, veneers, tissue and implant components may also be added to the master data file. The master data file may also be used to design various dental appliances including surgical guides.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A dental device comprising:
a marker;
an extension member configured to support the marker, and an anchor positioned adjacent to an oral structure, the anchor configured to releasably secure the extension member to the oral structure,
wherein at least one of the extension member and the anchor engage an upper surface of the oral structure.

2. The dental device of claim 1, wherein the marker is one of integral with the extension member and releasably engagable with the extension member.

3. The dental device of claim 1, wherein the marker is comprised at least partially of one of a radio-opaque material and a non radio-opaque material.

4. The dental device of claim 1, wherein the marker is at least one of a radiodensity reference marker and a negative marker.

5. The dental device of claim 1, wherein at least one of the extension member and the anchor further comprises a marker receptor configured to contain the marker.

6. The dental device of claim 1, wherein the anchor has at least one rest extending inwardly from the anchor toward an oral structure.

7. The dental device of claim 5, wherein the at least one rest is one of an occlusal rest and an undercut rest.

8. The dental device of claim 1, wherein the extension member and the anchor member are configured to form a substantially L-shaped dental device.

9. The dental device of claim 1, wherein at least one of the extension member and the anchor engages an occlusal surface of a tooth.

10. A dental device comprising:
a marker; and
an anchor positioned adjacent to an oral structure, the anchor configured to support the marker,
wherein the anchor engages an upper surface of the oral structure.

11. The dental device of claim 10, wherein the marker is one of integral with the anchor and releasably engagable with the anchor.

12. The dental device of claim 10, wherein the marker is comprised at least partially of one of a radio-opaque material and a non radio-opaque material.

13. A system for performing a dental procedure comprising:
a device having a marker and at least one of an extension member and an anchor, wherein at least one of the extension member and the anchor is positioned adjacent to an oral structure;
a tomography imaging scan of the mouth to create a tomography scan data set; and
a surface imaging scan of the mouth to create a surface scan data set, wherein the tomography scan data set and the surface scan data set may be aligned using an image of the device represented in the data sets.

14. The system of claim 13, wherein the marker is used to orient and verify data from the tomography scan data set and the surface scan data set to create a master data file.

15. The system of claim 14, wherein the master data file is used to create one of a digital diagnostic model and a physical diagnostic model.

16. The system of claim 15, wherein one of the digital diagnostic model and the physical diagnostic model is used to determine accurate placement of a dental implant before inserting the implant into the mouth.

17. The system of claim 13, further comprising a digital design of the device modeled from the surface scan data set.

18. The system of claim 17, wherein the digital design is used to align data from the tomography scan data set and the surface scan data set to create a master data file.

19. The system of claim 18, wherein the master data file is used to create one of a digital diagnostic model and a physical diagnostic model.

20. The system of claim 19, wherein one of the virtual diagnostic model and the physical diagnostic model is used to determine accurate placement of a dental implant before inserting the implant into the mouth.
